(19) United States
(12) Patent Application Publication
(10) Pub. No.: US 2018/0295245 A1
(43) Pub. Date: Oct. 11, 2018

(54) DISPLAY INPUT DEVICE AND METHOD FOR CONTROLLING SAME

(71) Applicant: KYOCERA Document Solutions Inc., Osaka (JP)

(72) Inventor: Shinichi KAWAGUCHI, Osaka (JP)

(73) Assignee: KYOCERA Document Solutions Inc., Osaka (JP)

(21) Appl. No.: 15/919,938

(22) Filed: Mar. 13, 2018

(30) Foreign Application Priority Data
Apr. 7, 2017 (JP) 2017-076898

(51) Int. Cl. H04N 1/00; G06F 3/01; G02B 27/01

(52) U.S. Cl. CPC H04N 1/00381; G06F 3/013; H04N 1/00474; H04N 1/00419; G02B 2027/0138; G02B 27/0172; G02B 2027/014; G02B 2027/0178; H04N 1/00503

(57) ABSTRACT

A display input device includes a head mount display and a main apparatus. The head mount display includes an imager, a transmissive display, a sight line detector, a processor, and an HMD communicator. The main apparatus includes an operation panel including a display panel and an operation portion, a main-apparatus communicator, and a controller. The processor causes the transmissive display to display a virtual item button for selecting an item. When an item belonging to a lowest hierarchical layer is selected, the controller causes the display panel to display a setting-value setting screen. The operation portion accepts setting of a setting value.

This application is based upon and claims the benefit of priority from the corresponding Japanese Patent Application No. 2017-076898 filed on Apr. 7, 2017, the entire contents of which are incorporated herein by reference.

### BACKGROUND

The present disclosure relates to a display input device including a main apparatus, which includes an operation panel, and a head mount display.

There are cases where an apparatus is provided with an operation panel to be operated for setting. For example, a user performs a touch operation on a key provided on an operation panel. By contrast, on a head mount display, it is possible to display virtual information. Hence, there are cases where a head mount display is configured to display a virtual operation panel. It is made possible to make settings in an apparatus also using such a virtual operation panel. An example of known technique in this field is described below.

Specifically, there is known a head mount display that operates in the following manner. The head mount display, while transmitting external light, projects image light to an eye of a user in accordance with display information for the user to visually recognize an image in accordance with the image light, captures an image of at least part of the range of the user's visual field, makes an analysis of the captured image, detects the user's hand based on the analysis, selects the position of a particular part of the detected user's hand as a reference position, and determines a position that is constantly in a predetermined positional relationship with the reference position as a display position at which a virtual operation panel, which follows the position of the user's hand, is to be displayed. The head mount display displays the virtual operation panel at the selected display position, detects operation performed by the user with a finger of his or hers, makes a judgment, based on the detected finger operation, on whether or not the virtual operation panel has been operated. When it is found that the virtual operation panel has been operated, the head mount display performs control corresponding to the position on the virtual operation panel at which the operation has been performed. This configuration aims at preventing inconsistency between the display position for displaying the virtual panel and the position at which the user performs operation.

In recent years, image forming apparatuses have been becoming equipped with more and more functions. The more functions an image forming apparatus is equipped with, the more settings need to be made for the image forming apparatus. Thus, the more functions an image forming apparatus is equipped with, the more complicated the setting operation tends to become. For example, the number of screens to be displayed on an operation panel increases. This tendency has hence led to a disadvantageously confusing hierarchical structure of setting (display screens) in some image forming apparatuses.

### SUMMARY

According to an aspect of the present disclosure, a display input device includes a head mount display and a main apparatus. The head mount display includes an imager, a transmissive display, a sight line detector, a processor, and an HMD communicator. The main apparatus includes an operation panel, a main-apparatus communicator, and a controller. The transmissive display, while transmitting external light, causes a virtual image to be visually recognized. The sight line detector detects a sight line of a user. The processor controls display on the transmissive display. The operation panel includes a display panel and an operation portion. The main-apparatus communicator communicates with the HMD communicator. The controller controls display on the display panel. While the imager is capturing an image of the operation panel, the processor causes the transmissive display to display a virtual item button for item selection. The processor recognizes, based on an output from the sight line detector, the virtual item button selected. The processor recognizes, as a selected item, an item corresponding to the virtual item button selected. The item is among a plurality of kinds of items, which are classified in a hierarchical structure. When the selected item belongs to a lowest hierarchy layer, the processor causes the HMD communicator to transmit, to the main-apparatus communicator, a first notification indicating the selected item. Based on the first notification, the controller causes the display panel to display a setting-value setting screen for setting a setting value for the selected item. The operation portion accepts setting of the setting value.

According to another aspect of the present disclosure, a method for controlling a display input device includes including a head mount display and a main apparatus in a display input device, causing a virtual image to be visually recognized using the head mount display while the head mount display transmitting external light, detecting a sight line of a user using the head mount display, providing the main apparatus with an operation panel which includes a display panel and an operation portion, controlling display on the display panel using the main apparatus, displaying, on the head mount display, a virtual item button for selecting an item while an imager of the head mount display is capturing an image of the operation panel, recognizing, based on a detected sight line, the virtual item button selected, recognizing, as a selected item, an item corresponding to the virtual item button selected, the item being one of a plurality of kinds of items which are classified in a hierarchical structure, the head mount display transmitting, to the main apparatus, a first notification indicating the selected item when the selected item belongs to a lowest hierarchical layer, the display panel displaying, based on the first notification, a setting-value setting screen for setting a setting value for the selected item, and accepting the setting of the setting value.

Further features and advantages of the present invention will become apparent from the description of embodiments given below.

### BRIEF DESCRIPTION OF THE DRAWINGS

FIG. 1 is a diagram illustrating an example of a display input device according to an embodiment.

FIG. 2 is a diagram illustrating an example of an operation panel according to the embodiment.

FIG. 3 is a diagram illustrating an example of a home screen according to the embodiment.

FIG. 4 is a diagram illustrating an example of the hierarchical structure of items in the display input device according to the embodiment.

FIG. 5 is a diagram illustrating an example of a setting-value setting screen according to the embodiment.

FIG. 6 is a diagram illustrating an example of the displaying state of the head mount display according to the embodiment.

FIG. 7 is a diagram illustrating an example of the displaying state of the head mount display according to the embodiment.

FIG. 8 is a diagram illustrating an example of the displaying state of the head mount display according to the embodiment.

FIG. 9 is a diagram illustrating an example of the displaying state of the head mount display according to the embodiment.

FIG. 10 is a flowchart illustrating an example of the flow of setting a setting value in the display input device according to the embodiment.

### DETAILED DESCRIPTION

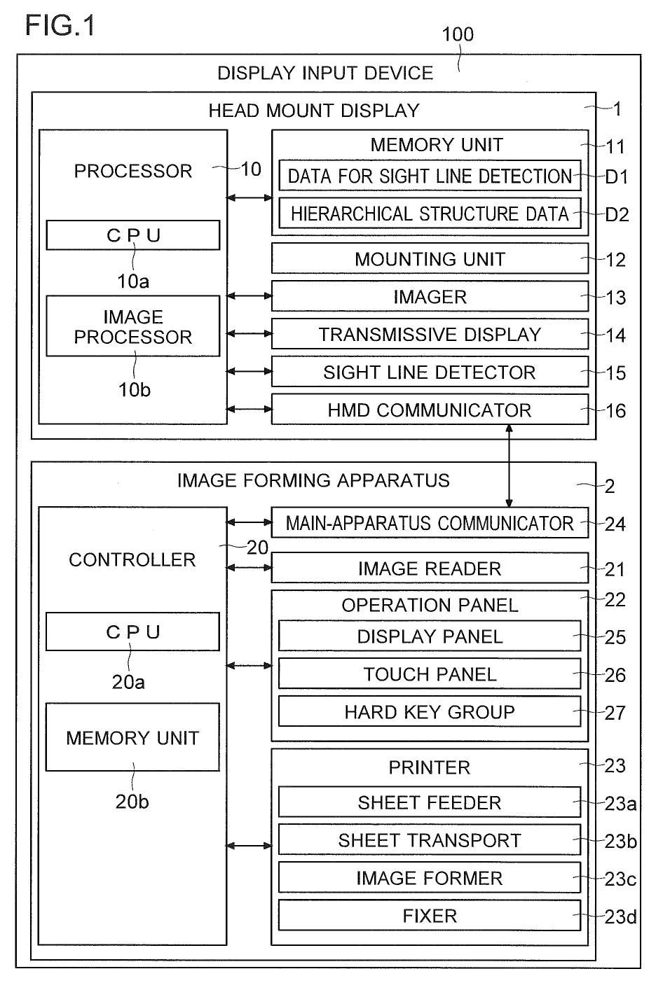

The present disclosure offers a clear hierarchical structure of items related to settings, and also allows accurate entry of setting values. Hereinafter, with reference to FIG. 1 to FIG. 10, a description will be given of a display input device 100 according to an embodiment of the present disclosure. It should be understood, however, that factors such as configurations and arrangements described herein are merely illustrative examples, and are not to be construed as limiting the present disclosure.

(Display Input Device 100)

With reference to FIG. 1, the display input device 100 according to the embodiment will be described. The display input device 100 includes a head mount display 1 and a main apparatus. The main apparatus is an object for which settings are made using the head mount display 1. In the following description, an image forming apparatus 2 will be taken as an example of the main apparatus.

As the head mount display 1, an optical transmissive type (optical see-through type) head mount display may be used. As shown in FIG. 1, the head mount display 1 includes a processor 10, a memory unit 11, a mounting unit 12, an imager 13, a transmissive display 14, a sight line detector 15, and an HMD communicator 16.

The processor 10 includes a CPU 10a and an image processor 10b. The processor 10 is communicably connected to the memory unit 11, the imager 13, the transmissive display 14, the sight line detector 15, and the HMD communicator 16. The memory unit 11 includes a RAM and a ROM. The memory unit 11 stores therein programs and data related to the control of the head mount display 1. Based on the programs and data stored in the memory unit 11, the processor 10 causes the transmissive display 14 to display an image. The processor 10 also causes the HMD communicator 16 to perform communication with the image forming apparatus 2.

The mounting unit 12 is a mechanism for mounting the head mount display 1 on the head of a user. As the head mount display 1, an eye-glasses type head mount display may be used. The mounting unit 12 includes a front frame and two rear frames. At each end of the front frame, one end of one of the rear frames is fitted. Part (nose pads) of the front frame contacts the face of the user, at an upper portion of his or her nose (below the brow). The other end of each of the rear frames is hooked on one of the ears of the user. Here, the head mount display 1 may be a helmet-type head mount display.

The imager 13 is a camera disposed in the head mount display 1. The imager 13 includes a lens, an image sensor, and a camera module. The camera module produces image data (captured image) based on an image signal that the image sensor outputs. The imager 13 is disposed so as to capture an image of a scene in the sight direction of the user. The processor 10 analyzes the captured image. The processor 10 recognizes what is included in the captured image. For example, the processor 10 recognizes whether or not the captured image includes an operation panel 22 of the image forming apparatus 2.

The transmissive display 14 includes a light-transmitting plate and an incidence portion. The light-transmitting plate is disposed at a position opposing an eye of the user. The light-transmitting plate transmits light. Thus, the user is able to visually recognize a scene (an object) even when he or she is wearing the head mount display 1. The processor 10 transmits, to the incidence portion, image data of an image that is to be virtually displayed. The processor 10 controls display on the transmissive display 14 (the incidence portion). Based on the image data received, the incidence portion emits image light of the image to be virtually displayed. The incidence portion causes the image light to enter the eye (pupil, eye ball) of the user. The head mount display 1 (the transmissive display 14), while transmitting external light, causes the user to visually recognize the virtually displayed image. The incidence portion includes a portion (a light emitter) that emits the image light. The light emitter is, for example, a liquid crystal display, an organic EL display, or a retinal scanning display. The image light may be caused to directly enter the eye of the user. Alternatively, the image light may be caused to enter the eye of the user using a half mirror. In a case where a half mirror is provided, light emitted from the incidence portion is reflected by the half mirror such that the image light is caused to enter the pupil of the user.

The sight line detector 15 detects the sight line of the user. The sight line detector 15 is, for example, a camera which captures an image of a pupil. In this case, image data (image data for sight line detection) acquired by imaging performed by the sight line detector 15 is transmitted to the processor 10. The processor 10 calculates the position (coordinates) of the center of an iris based on the image data for sight line detection. Based on the calculated position of the center of the iris, the processor 10 detects the position of a point (viewpoint) on the transmissive display 14 (the light-transmitting plate) at which the user is looking. The processor 10 detects a sight line direction (the direction in which the user is looking). In the memory unit 11, for example, data D1 for sight line detection is stored. The data D1 for sight line detection is data which defines positions of viewpoints corresponding to positions of the center of the iris. The processor 10 refers to the data D1 for sight line detection to detect the position of a point (viewpoint) at which the user is looking.

Here, the sight line detector 15 may be a sensor which detects an electric field and thereby detects a direction in which an eye ball is pointing. For example, the mounting unit 12 is provided with two sensors which detect the direction of an electric field. The sensors are each disposed facing one of the temples of the user. Here, the retina in an eye ball is negatively charged. By contrast, the cornea is positively charged. An electric field is generated between the cornea and the retina. The direction of this electric field changes depending on the movement (direction) of the eye ball. The sensors detect the direction of the electric field. The processor 10 may detect the sight line direction of the user based on the outputs of these sensors.

Next, the image forming apparatus 2 (the main apparatus) will be described. The image forming apparatus 2 illustrated in FIG. 1 is a multifunction peripheral. The image forming apparatus 2 may be any other type of image forming apparatus, such as a printer or a copier. The image forming apparatus 2 includes a controller 20, an image reader 21, an operation panel 22, a printer 23, and a main-apparatus communicator 24.

The controller 20 controls operation of the image forming apparatus 2. The controller 20 includes a CPU 20a and a memory unit 20b. The memory unit 20b is constituted by a combination of storage devices such as a ROM, a RAM, an HDD, and so on. The memory unit 20b stores therein data, settings, and programs for controlling the image forming apparatus 2. The memory unit 20b is capable of storing therein image data as well. The CPU 20a controls the image forming apparatus 2 based on the programs and the data stored in the memory unit 20b.

In a job (such as a copy job or a transmission job) in which document reading is performed, the controller 20 causes the image reader 21 to read a document. The image reader 21 includes optical members such as an exposure lamp, a mirror, a lens, a line sensor, and so on (of which none are illustrated). The image reader 21 produces image data of the read document. The operation panel 22 accepts operation and settings performed and made thereon by the user. The operation panel 22 will be described later in detail.

The printer 23 includes a sheet feeder 23a, a sheet transport 23b, an image former 23c, and a fixer 23d. In a job in which printing is performed, the controller 20 causes the sheet feeder 23a to feed a sheet. The controller 20 causes the sheet transport 23b to transport the sheet along a sheet transport path inside the apparatus. The controller 20 causes the image former 23c to form a toner image based on the image data of an image to be formed. The controller 20 causes the fixer 23d to fix the toner image on the sheet after the toner image is transferred onto the sheet.

The main-apparatus communicator 24 is capable of performing wireless communication with the HMD communicator 16. In other words, the main-apparatus communicator 24 communicates with the head mount display 1. The main-apparatus communicator 24 is also capable of performing communication with a computer, a facsimile machine, and so on, via a communication network. The main-apparatus communicator 24 receives printing data from a computer. The printing data includes image data and data written in a page description language. The controller 20 causes the printer 23 to perform printing (a print job) based on the received printing data. It is also possible to transmit image data from the main-apparatus communicator 24 to an external computer. For example, it is possible to transmit image data obtained by reading performed by the image reader 21 to a computer, a facsimile machine, or the like (a scan job, a FAX job).

(Operation Panel 22)

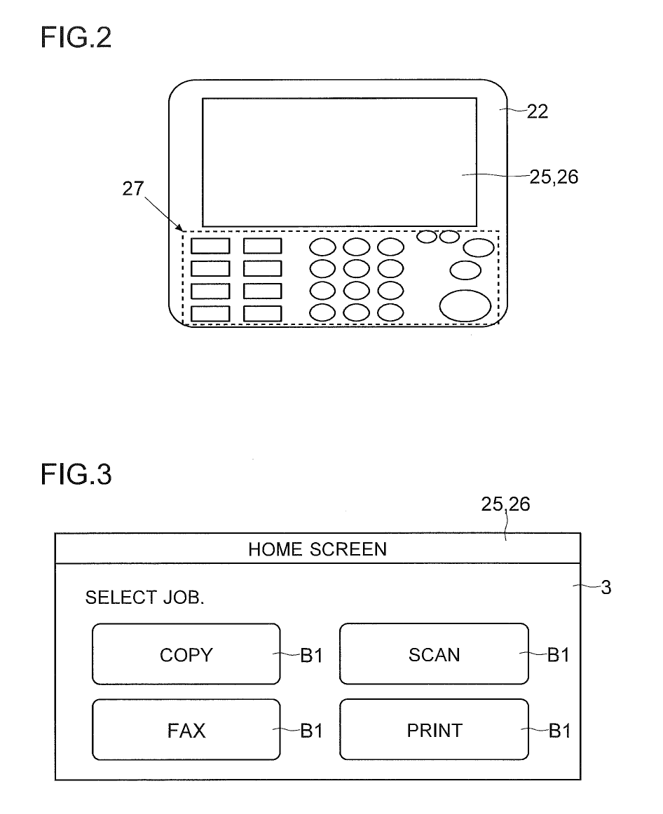

Next, with reference to FIG. 2, a description will be given of an example of the operation panel 22 according to the embodiment. The image forming apparatus 2 includes the operation panel 22. Based on a signal from the operation panel 22, the controller 20 recognizes set contents. The operation panel 22 includes a display panel 25, a touch panel 26 (corresponding to an operation portion), and a hard-key group 27 (corresponding to the operation portion). The touch panel 26 is mounted on the display panel 25. The controller 20 controls display on the display panel 25. The controller 20 causes operation images to be displayed within a screen. The operation images are, for example, a button, a tab, a key, a check box, and so on. The touch panel 26 detects a touch position at which it is touched by the user. The controller 20 recognizes, based on an output of the touch panel 26, which of the operation images has been operated (touched).

The operation panel 22 includes the hard-key group 27. The hard-key group 27 includes a plurality of hard keys. For example, a start key (used for giving an instruction to execute a job) and a numerical key pad (used to enter numerals) are included in the hard-key group 27. When one of these hard keys is pressed, the operation panel outputs a signal corresponding to the pressed key. Based on the output signal of the operation panel 22, the controller 20 recognizes the hard key that has been operated. The controller 20, based on settings made by the user, operates the image reader 21, the printer 23, and the main-apparatus communicator 24.

(Job Selection on Operation Panel 22)

Next, with reference to FIG. 3, a description will be given of an example of job selection on the operation panel 22 according to the embodiment. It is possible to have a plurality of kinds of jobs performed by the image forming apparatus 2. The image forming apparatus 2 has a plurality of functions. The image forming apparatus 2 is capable of performing jobs such as a copy job, a scan job, a fax job, a print job, and so on.

The controller 20 causes the display panel 25 to display a home screen 3. The home screen 3 is a screen for selecting a job kind. The home screen 3 is a screen belonging to a highest hierarchical layer. As illustrated in FIG. 3, job kind buttons B1 are displayed on the home screen 3. The job kind buttons B1 are buttons for selecting a job kind. FIG. 3 illustrates an example in which four job kind buttons B1 are displayed on the home screen 3. The job kind buttons B1 each correspond to one of copy, scan, fax, and print jobs. The controller 20 causes the display panel 25 to display, inside each of the job kind buttons B1, the name of the job kind to which the job kind button B1 corresponds. The user operates one of the job kind buttons B1 that corresponds to the job to be executed.

The controller 20 causes the display panel 25 to display the home screen 3 when the image forming apparatus 2 is turned on, when the image forming apparatus 2 is recovered from a power saving mode, or when a job is completed. When a predetermined time has passed without any operation performed since the performance of the last operation on the operation panel 22, the controller 20 automatically resets the screen and the settings. On the resetting, the controller 20 causes the display panel 25 to display the home screen 3. Job setting starts from the home screen 3 as a starting point. With selection of a job kind on the home screen 3 as a trigger, settings related to the job starts to be made.

(Hierarchical Structure of Items and Setting of Setting Values)

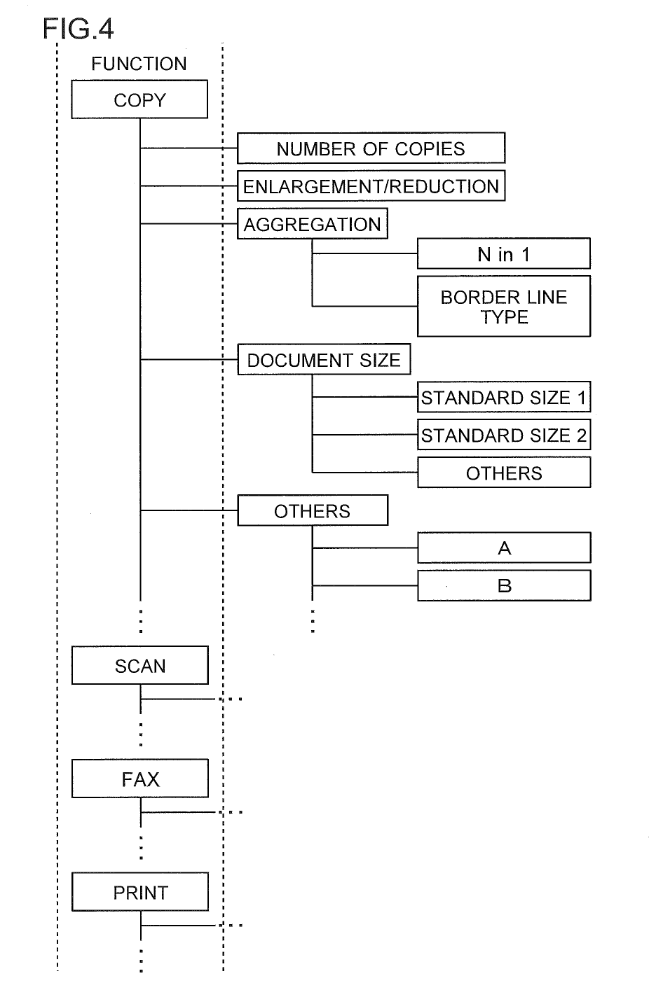

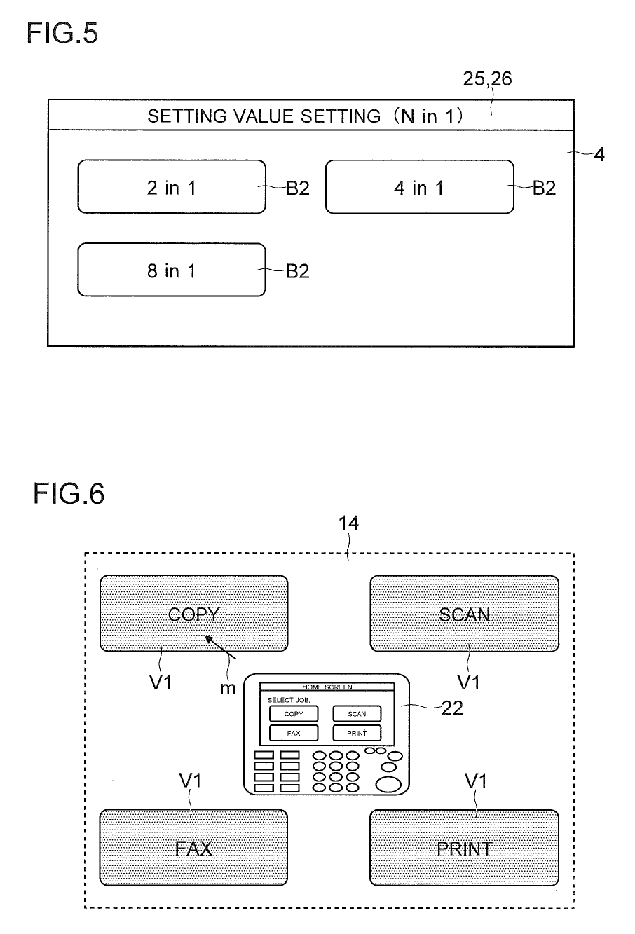

Next, with reference to FIG. 4 and FIG. 5, a description will be given of an example of the hierarchical structure of items and an example of the setting of setting values in a display input device 100. In the display input device 100, settings can be made for the operation of the image forming apparatus 2. The user sets the setting values to obtain a desired job result. The number of setting values sellable is large. The user repeatedly selects items starting from the highest hierarchical layer, until he or she reaches a screen for setting his or her desired setting value. In the image forming apparatus 2, a plurality of kinds of setting items are provided. A plurality of setting items are provided for each job kind.

The items are classified in a hierarchical structure. There is a case where item names are names of groups (names of classes) each including a plurality of items. In such a case, the user selects a class from major classes, and then selects an item, for setting a desired setting value, from items in the selected class. When the selected item is one classified as belonging to the lowest hierarchical layer, the setting value is allowed to be set. Items classified as belonging to the lowest hierarchical layer do not have an item below them.

FIG. 4 illustrates an example of the hierarchical structure (tree structure) of items related to settings. In FIG. 4, the leftmost column represents job kind (function). For example, directly under each job kind, frequently used items are arranged. There is a case where an item has a sub item or a plurality sub items linked thereto. In the example illustrated in FIG. 4, the item “Nin1” and the item “border line type” are sub items of the item “aggregation”. The items “Nin1” and “border line type” belong to the lowest hierarchical layer. Further, in the example illustrated in FIG. 4, the item “standard size 1” (corresponding to A series and Japanese B-series variant), the item “standard size 2” (corresponding to inch-based paper size), and the item “others” (corresponding to sheets such as envelopes) are sub items of the item “document sheet size”.

Here, in aggregation printing, contents of a plurality of document sheets are printed on one sheet. For example, when the setting value of 2in1 is set, contents of two document pages are printed on one sheet. Aggregation printing is sometimes set for the purpose of saving sheets. When the item “Nin1” is selected, it is possible to set, as a setting value, the number of document pages to be included in one page. When the item “border line type” is selected, it is possible to set a setting value related to the border line of each page.

Next, setting of setting values will be described. For example, when the user wishes to set the setting value of 2in1 in a copy job, the user selects “copy job”. Then, the user selects the item “aggregation”. After selecting the item “aggregation”, the item “Nin1” needs to be selected. When the item “Nin1”, which belongs to the lowest hierarchical layer, has been selected, the controller 20 causes the display panel 25 to display a setting-value setting screen 4 illustrated in FIG. 5.

When an item classified as belonging to the lowest hierarchical layer has been selected, the controller 20 causes the display panel 25 to display the setting-value setting screen 4. In displaying the setting-value setting screen 4, the controller 20 causes the display panel 25 to display setting value buttons B2. Within each of the setting value buttons B2, one selectable setting value is written. FIG. 5 illustrates an example where setting value buttons B2 respectively corresponding to setting values of 2in1, 4in1, and 8in1 are displayed. In a case where the user wishes to set the setting value of 2in1, he or she operates one of the setting buttons B2 that corresponds to 2in1.

Based on an output of the operation panel 22, the controller 20 recognizes that the setting value of 2in1 has been set. When the setting value of 2in1 has been set, the controller 20 produces image data such that contents of two document pages are contained in one page (a plurality of pages are aggregated in one page). The controller 20 causes the printer 23 to perform printing based on the thus produced image data. As a result, printed matter is obtained in which each page contains contents of two document pages.

The image forming apparatus 2 has a hierarchical structure of items. In other words, to set a desired setting value, the user performs item selection once or a plurality of number of times, descending (going down along) the hierarchy. The user needs to reach a screen for setting the desired setting value. Hierarchical structure data D2, which defines the hierarchical structure of the items, is stored in the memory unit 11 of the head mount display 1 (see FIG. 1). Based on the hierarchical structure data D2, the processor 10 recognizes the hierarchical structure related to items and settings.

(Setting of Setting Values Using Head Mount Display 1)

Next, with reference to FIG. 6 to FIG. 9, a description will be given of setting of setting values using the head mount display 1 according to the embodiment. The description here will deal with an example where the setting of a setting value is started from the home screen 3. An example of setting the setting value of 2in1 in a copy job will be described. The description applies to setting other setting values.

The user puts on the head mount display 1. In a case of setting a setting value using the head mount display 1, the user needs to keep looking at the operation panel 22. The processor 10 analyzes a captured image. The processor 10 makes a judgment on whether or not the imager 13 is capturing an image of the operation panel 22 (whether or not the operation panel 22 is included in the captured image). In other words, the processor 10 makes a judgment on whether or not the user is looking at the operation panel 22.

How to recognize whether or not the imager 13 is capturing an image of the operation panel 22 is appropriately determined. For example, the operation panel 22 is provided with an identification marker. The marker may be disposed on the operation panel 22 in any manner, including by affixing a label thereon, by painting or printing the marker thereon, and so on. The marker is a figure having a predetermined pattern. When the marker is included in the captured image, the processor 10 makes a judgment that the imager 13 is capturing an image of the operation panel 22. When the marker is not included in the captured image, the processor 10 makes a judgment that the imager 13 is not capturing an image of the operation panel 22. Here, the processor 10 may make these judgments based on the shape and the color of the operation panel 22, and the colors and the arrangement of the keys, the buttons, and so on in the hard-key group 27.

When capturing of an image of the operation panel 22 is started, the processor 10 causes the HMD communicator 16 to transmit, to the main-apparatus communicator 24, a request for information about a button displayed on the operation panel 22. On receiving the request, the controller 20 causes the main-apparatus communicator 24 to transmit, to the HMD communicator 16, information of the kind of the button displayed on the operation panel 22. With this information, the processor 10 is able to recognize the screen and its contents displayed on the operation panel 22. The following description will deal with a case where the controller 20 causes the main-apparatus communicator 24 to transmit information about a button displayed on the home screen 3.

When the user starts to look at the operation panel 22 with the home screen 3 displayed, the processor 10 causes the transmissive display 14 to display virtual job kind buttons V1 for selecting a job kind. FIG. 6 illustrates an example of the displaying state of the head mount display 1 when the virtual job kind buttons V1 are displayed. Here, as illustrated in FIG. 6, the operation panel 22 is visible to the user through the transmissive display 14. Specifically, the processor 10 causes the transmissive display 14 to virtually display four virtual job kind buttons V1 (corresponding to the job kind buttons B1 displayed on the home screen 3) which respectively correspond to the copy, scan, fax, and print jobs. The processor 10 causes the transmissive display 14 to display, inside each of the virtual job kind buttons V1, the name of the job kind to which the virtual job kind button corresponds.

Then, the processor 10 causes the transmissive display 14 to display a sight line position mark “m”. Based on an output of the sight line detector 15, the processor 10 recognizes a sight line (viewpoint) position. The sight line position mark “m” indicates the sight line (viewpoint) position that the processor 10 has recognized. The sight line position marks “m” in FIG. 6 to FIG. 9 are arrow marks. The leading end of each of the arrow marks indicates the sight line (viewpoint) position that is currently recognized. The user can move the arrow mark by moving his or her sight line (eye ball).

Based on the output of the sight line detector 15, the processor 10 recognizes a selected virtual job kind button V1. The processor 10 recognizes, as the selected virtual job kind button V1, one of the virtual job kind buttons V1 that has been looked at (in other words, on which the user's sight line has stayed) for a reference time or longer. And, the processor 10 recognizes that a job corresponding to the selected virtual job kind button V1 has been selected. The user gazes at one of the virtual job kind buttons V1 that corresponds to the job (function) he or she wishes to select. In a case of setting 2in1 copying, the processor 10 recognizes that one of the virtual job kind buttons V1 that corresponds to the copy job has been selected.

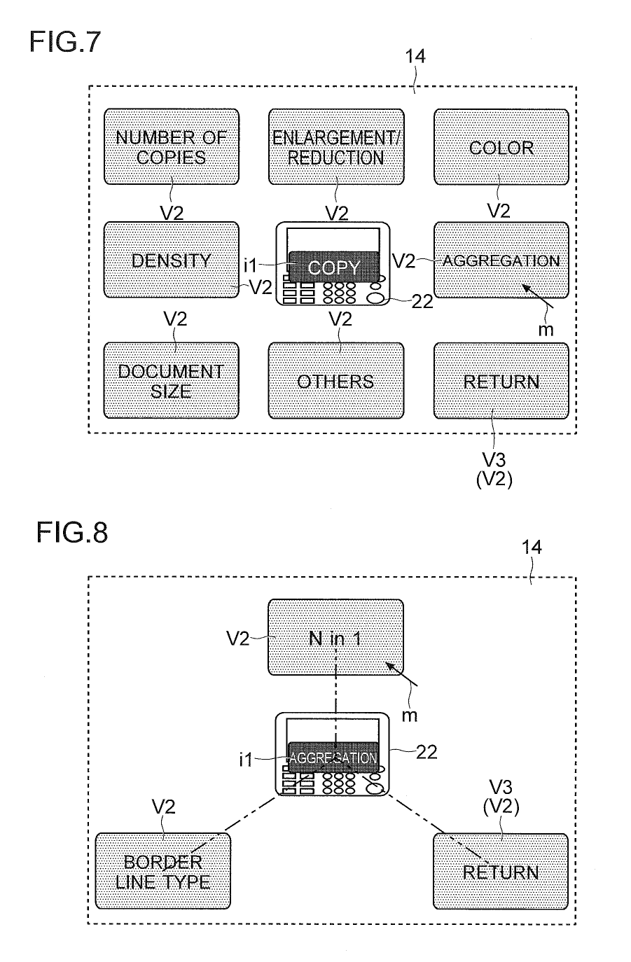

When a job has been selected, the processor 10 causes the transmissive display 14 to display virtual item buttons V2 corresponding to items related to the selected job and classified as belonging to the highest hierarchical layer. FIG. 7 illustrates an example of the displaying state of the head mount display 1 when the copy job has been selected. The processor 10 causes the transmissive display 14 to display, inside each of the virtual item buttons V2, the name of the item to which the virtual item button V2 corresponds. Further, as illustrated in FIG. 7, the processor 10 causes the transmissive display 14 to display the virtual item buttons V2 such that they are aligned in one or both of the longitudinal direction and the lateral direction.

Based on the output of the sight line detector 15, the processor 10 recognizes a selected virtual item buttons V2. The processor 10 recognizes, as the selected virtual item button V2, one of the virtual item buttons V2 that has been looked at (in other words, on which the user's sight line has stayed) for the reference time or longer. The processor 10 recognizes an item corresponding to the selected virtual item button V2 as the selected item. The user gazes at one of the virtual item buttons V2 that corresponds to the item he or she wishes to select. The present description deals with a case where the user sets 2in1. In this case, the user gazes at one of the virtual item buttons V2 that corresponds to “aggregation”. As a result, the processor 10 recognizes the item “aggregation” as the selected item.

When the selected item does not belong to the lowest hierarchical layer, the processor 10 causes the transmissive display 14 to display an item display image i1, which is an image indicating the selected item. The processor 10 causes the transmissive display 14 to display, around the item display image i1, virtual item buttons V2 corresponding to items classified as belonging to a hierarchical layer immediately below the hierarchical layer to which the selected item belongs. FIG. 8 illustrates an example of the display state of the head mount display 1 when the item “aggregation” has been selected. In the present description, the user sets the setting value of 2in1. In this case, the user gazes at one of the virtual item buttons V2 that corresponds to Nin1. The processor 10 recognizes the item “Nin1” as the selected item.

Further, as illustrated in FIG. 8, the processor 10 may cause the transmissive display 14 to display the virtual item buttons V2 in such a manner that an angle between any two adjacent ones of lines (alternate long and two short dashes lines), each connecting the center of the display region of the head mount display 1 and the center of one of the virtual item buttons, is equal to an angle obtained by dividing an angle of 360° by the number of virtual item buttons V2 displayed. Thereby, it is possible to evenly distribute the virtual item buttons V2 over the screen. Also, it becomes easy to arrange the virtual buttons V2 with a sufficient distance therebetween.

In the case illustrated in FIG. 8, three virtual item buttons V2 are displayed. They are specifically a return button V3, virtual item buttons V2 respectively corresponding to items “Nin1” and “border line type” (details of which will be given later). The return button V3 is one variety of virtual item button V2. FIG. 8 illustrates an example in which the virtual item buttons V2 are arranged around the center of the display region of the head mount display 1 at intervals of 120°.

The return button V3 is a button used to deal with a case where a wrong virtual button has been selected. The processor 10 causes the transmissive display 14 to display the return button V3 while displaying the virtual item buttons V2. When the return button V3 is selected by the user with his or her sight line, the processor 10 causes the transmissive display 14 to display the virtual item buttons V2 corresponding to items belonging to a hierarchical layer immediately above the current hierarchical layer. In other words, the hierarchical layer is caused to return to one immediately above the current hierarchical layer.

On the other hand, when the selected item is an item (an item belonging to the lowest hierarchical layer) which has no item therebelow, the processor 10 causes the HMD communicator 16 to transmit a first notification to the main-apparatus communicator 24. The first notification indicates the selected item. Based on the first notification received by the main-apparatus communicator 24, the controller 20 recognizes the selected item. The controller 20 causes the display panel 25 to display a setting-value setting screen 4. The setting-value setting screen 4 is a screen for setting a setting value for the selected item. The present description deals with an example where the selected item is Nin1. In this case, the controller 20 displays the setting-value setting screen 4 illustrated in FIG. 5. For final setting of a setting value, the user needs to touch the operation panel 22.

Selection of a virtual button only by using a sight line sometimes results in erroneous selection of a virtual button. In a case where an erroneous setting value has been set, the setting value needs to be corrected. It requires a troublesome operation to correct a setting value. To prevent such trouble, it is made impossible for the user to select a final setting value by moving his or her sight line on the head mount display 1.

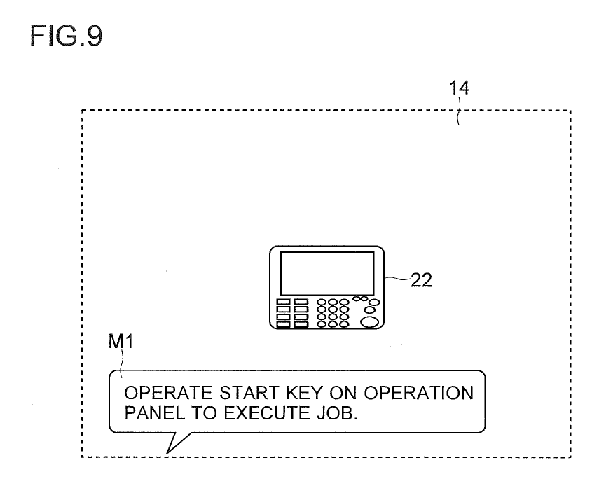

Furthermore, when the touch panel 26 has accepted setting of a setting value, the controller 20 causes the main-apparatus communicator 24 to transmit a second notification to the HMD communicator 16. The second notification indicates that a setting value has been set. The processor 10 keeps the transmissive display 14 from displaying any virtual button during a period from when a virtual button V2 corresponding to an item classified as belonging to the lowest hierarchical layer is selected until when the second notification is received (in short, during a virtual button display suspension period). Specifically, the processor 10 keeps the transmissive display 14 from displaying the virtual item buttons V2 and the return button V3. FIG. 9 illustrates an example of the displaying state of the head mount display 1 during the virtual button display suspension period.

Moreover, for the purpose of preventing a job from being started unintentionally, no instruction to start execution of a job is allowed to be given using the head mount display 1.

In other words, the processor 10 does not accept an instruction to start executing a job (selected function). For the user's convenience, as illustrated in FIG. 9, during the virtual button display suspension period, the processor 10 causes the transmissive display 14 to display a message regarding the starting of job execution. A message M1 in the figure tells that the user needs to operate the touch panel 26 or the hard-key group 27 of the image forming apparatus 2 to execute a job. Here, the processor 10 may cause the transmissive display 14 to display the message M1 out of the virtual button display suspension period, too.

(Flow of Setting Value Selection)

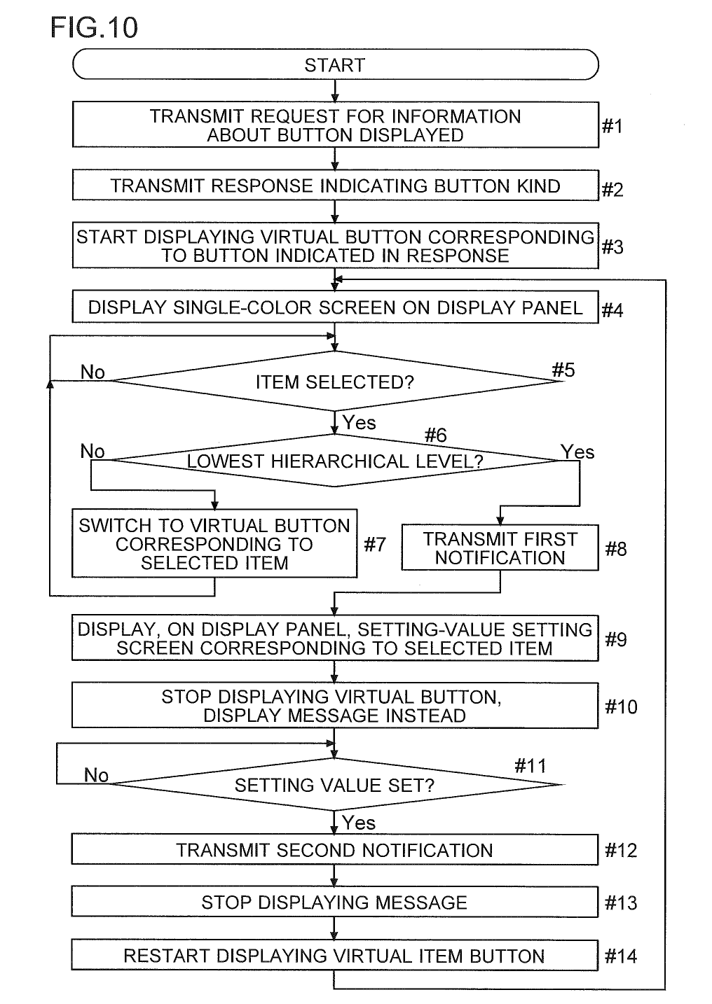

Next, with reference to FIG. 10, a description will be given of an example of the flow of setting a setting value in the display input device 100 according to the embodiment. START in FIG. 10 is a time point at which the processor 10 recognizes that capturing of an image of the operation panel 22 has started. First, the processor 10 causes the HMD communicator 16 to transmit a request for information about a button displayed on the display panel 25 (step #1). The controller 20 causes the main-apparatus communicator 24 to transmit a response to the HMD communicator 16 (step #2). The response includes information indicating the kind of the button displayed on the display panel 25. When the home screen 3 is displayed, the controller 20 causes the main-apparatus communicator 24 to transmit a response indicating that the job kind buttons B1 (COPY, SCAN, FAX, PRINT) are currently displayed. When a job has already been selected, the controller 20 causes the main-apparatus communicator 24 to transmit a response indicating the displayed item button.

The processor 10 causes the transmissive display 14 to display a virtual button corresponding to the button indicated in the response (step #3). Thereby, display of the virtual button is started. When the response indicates the job kind buttons B1, the processor 10 causes the transmissive display 14 to display the virtual job kind buttons V1. When the response indicates item buttons, the processor 10 causes the transmissive display 14 to display the virtual item buttons V2.

Along with the start of displaying the virtual buttons, the controller 20 may cause the display panel 25 to display a single-color screen (step #4). The color of the single-color screen is appropriately determined. For example, the color may be white or black. For example, the controller 20 may cause the display panel 25 to display a completely white screen.

While the transmissive display 14 is displaying the virtual buttons, the controller 20 keeps the display panel 25 from displaying buttons. That is, while the head mount display 1 is capturing an image of the operation panel 22, the user is not allowed to select an item on the operation panel 22. However, setting of setting values is performed via the touch panel 26 and the hard-key group 27. Thus, the device on which to select an item and the device on which to set a setting value are clearly separate.

Next, based on the output of the sight line detector 15, the processor 10 continues to check whether an item has been selected (whether or not any one of the virtual item buttons V2 has been gazed at) (step #5, when No at step #5, step #5 is repeated). When an item has been selected (Yes at step #5), the processor 10 checks whether the item is classified as belonging to the lowest hierarchical layer (step #6).

When the item does not belong to the lowest hierarchical layer (No at step #6), the processor 10 switches virtual buttons to be displayed (step #7). Specifically, the processor 10 causes the transmissive display 14 to display virtual buttons belonging to a hierarchical layer immediately below the hierarchical layer to which the selected item belongs. Here, when the return button V3 has been selected, the processor 10 causes the transmissive display 14 to display the virtual item buttons V2 corresponding to the items belonging to a hierarchical layer immediately above the hierarchical layer to which the selected item belongs. Then, the flow returns to step #5.

When the item belongs to the lowest hierarchical layer (Yes at step #6), the processor 10 causes the HMD communicator 16 to transmit the first notification (indicating the selected item) to the main-apparatus communicator 24 (step #8). On receiving the first notification, the controller 20 causes the display panel 25 to display a setting-value setting screen 4 corresponding to the selected item indicated in the first notification (step #9). The processor 10 also stops the display of virtual buttons. The processor 10 causes the transmissive display 14 to display the message M1 related to job execution instead (step #10).

The controller 20 continues checking whether setting of a setting value (operation on any one of the setting value buttons B2) has been performed (step #11, when No at step #11, step #11 is repeated). When a setting value has been set (Yes at step #11), the controller 20 causes the main-apparatus communicator 24 to transmit to the HMD communicator 16 the second notification indicating that a setting value has been set (step #12).

On receiving the second notification, the processor 10 causes the transmissive display 14 to stop displaying the message M1 (step #13). Then, the processor 10 causes the transmissive display 14 to restart displaying the virtual item buttons V2 (step #14). When a setting value has been set, for example, the processor 10 may cause the transmissive display 14 to display the virtual item buttons V2 corresponding to items displayed when the job kind is selected (see FIG. 7). Alternatively, the processor 10 may cause the transmissive display 14 to display the virtual item buttons V2 displayed when the item belonging to the lowest hierarchical layer is selected. Then the flow returns to step #4. The flow is repeated until the start key is operated (that is, until the job starts to be executed). When the start key is operated, the flow is finished. Instead, the job starts to be executed.

As has been described above, the display input device (system) 100 according to the embodiment includes the head mount display 1 and the main apparatus (the image forming apparatus 2). The head mount display 1 includes the imager 13, the transmissive display 14, the sight line detector 15, the processor 10, and the HMD communicator 16. The transmissive display 14, while transmitting external light, causes a virtual image to be visually recognized. The sight line detector 15 detects the sight line of the user. The processor 10 controls display on the transmissive display 14. The main apparatus includes the operation panel 22, the main-apparatus communicator 24, and the controller 20. The operation panel 22 includes the display panel 25 and the operation portion (the touch panel 26 and the hard-key group 27). The main-apparatus communicator 24 communicates with the HMD communicator 16. The controller 20 controls display on the display panel 25. The processor 10, while the imager 13 is capturing an image of the operation panel 22, causes the transmissive display 14 to display the virtual item buttons V2 for selecting an item. The processor 10, based on the output of the sight line detector 15, recognizes a selected virtual item buttons V2. The processor 10 recognizes an item corresponding to the selected virtual item button V2 as a selected item. There are provided a plurality of kinds of items, which are classified in a hierarchical structure. When the selected item is an item belonging to the lowest hierarchical layer, having no item therebelow, the processor 10 causes the HMD communicator 16 to transmit, to the main-apparatus communicator 24, the first notification indicating the selected item. Based on the first notification, the controller 20 causes the display panel 25 to display the setting-value setting screen 4 for setting a setting value for the selected item. The operation portion accepts the setting of the setting value.

Thereby, the virtual item buttons V2 including the names of selectable items are displayed on the transmissive display 14. The screen of the head mount display 1 appears large to the user. Buttons for selecting items are perceived as large buttons. And, the virtual item buttons V2 corresponding to items belonging to the same hierarchical layer (the same group) are displayed on the transmissive display 14 in an at-a-glance manner. This facilitates understanding of the hierarchical structure of the items. When an item is selected which belongs to the lowest hierarchical layer, having no item therebelow, it is possible to cause the display panel 25 to display the setting-value setting screen 4 for setting a setting value for the selected item. This makes it possible to actually operate the operation panel 22 to set the setting value. Thus, compatibility is achieved between an easily understandable hierarchical structure of items related to setting and accurate entry of setting values. This contributes to the improved user-friendliness of the display input device 100.

When an item is selected which does not belong to the lowest hierarchical layer, the processor 10 causes the transmissive display 14 to display the item display image i1, which indicates the selected item, and causes the transmissive display 14 to display, around the item display image i1, the virtual item buttons V2 corresponding to the items classified as belonging to the hierarchical layer immediately below the hierarchical layer to which the selected item belongs. Thereby, the virtual item buttons V2 corresponding to the items belonging to the hierarchical layer immediately below the hierarchical layer to which the selected item belongs are displayed in an at-a-glance manner. This facilitates understanding of the hierarchical connection between items.

While the transmissive display 14 is displaying the virtual item buttons V2, the controller 20 causes the display panel 25 to display a single-color screen. Thereby, on the operation panel 22, screens in the process of descending to lower hierarchical layers are not displayed. In other words, the operation panel 22 does not display screens except for a screen indicating items belonging to the lowest hierarchical layer. It is possible to restrict the screen to be displayed on the display panel 25 to the setting-value setting screen 4. It is possible to help the user recognize that he or she should set a setting value, immediately when a screen is displayed on the display panel 25.

The processor 10 causes the transmissive display 14 to display the message M1 telling that the user needs to operate the operation portion of the main apparatus to execute the job. Thereby, it is possible to inform the user (the wearer) of the operation that he or she needs to perform to execute the job.

When the operation panel 22 has accepted the setting of a setting value, the controller 20 causes the main-apparatus communicator 24 to transmit, to the HMD communicator 16, the second notification indicating that the setting value has been set. The processor 10 keeps the transmissive display 14 from displaying virtual buttons during a period from when one of the virtual item buttons V2 which corresponds to an item classified as belonging to the lowest hierarchical layer is selected until when the second notification is received. Thus, setting values are sellable exclusively by operating the operation panel 22. It is possible to prevent the setting from being affected by the movement of the sight line on the head mount display 1.

The processor 10 causes the transmissive display 14 to display virtual item buttons V2 such that an angle between any two adjacent ones of lines each connecting the center of the display region of the head mount display 1 and the center of one of the virtual item buttons V2 is equal to an angle obtained by dividing an angle of 360° by the number of the virtual item buttons V2 displayed. Thereby, it is possible to arrange the virtual item buttons V2 such that they are easily seen. It is also possible to arrange the virtual item buttons V2 with a sufficient distance therebetween. Accordingly, it is possible to reduce erroneous selection of the virtual item buttons V2.

The processor 10 causes the transmissive display 14 to display the virtual item buttons V2 such that they are aligned in one or both of the longitudinal direction and the lateral direction. Thereby, it is possible to arrange the virtual item buttons V2 such that they are easily seen and also in an orderly manner.

The controller 20 causes the display panel 25 to display the home screen 3 for selecting a job kind. While the imager 13 is capturing an image of the home screen 3, the processor 10 causes the transmissive display 14 to display the virtual job kind buttons V1 for selecting a job kind. The processor 10, based on the output of the sight line detector 15, recognizes a selected virtual job kind button V1. The processor 10 causes the transmissive display 14 to display the virtual item buttons V2 corresponding to the items for the selected job kind and classified as belonging to the highest hierarchical layer. This allows the user to select a job kind (a function to use) by the movement of his or her sight.

The embodiments of the present disclosure described herein are not meant to limit the scope of the present disclosure in any manner. The present disclosure may be implemented by making various modifications thereto without departing from the spirit of the present disclosure.

What is claimed is:

1. A display input device comprising:
a head mount display; and
a main apparatus,
wherein the head mount display comprises
an imager,
a transmissive display which, while transmitting external light, causes a virtual image to be visually recognized,
a sight line detector for detecting a sight line of a user,
a processor which controls display on the transmissive display, and
an HMD communicator,
wherein the main apparatus comprises
an operation panel which includes a display panel and an operation portion,
a main-apparatus communicator which communicates with the HMD communicator, and
a controller which controls display on the display panel,
wherein the processor
causes the transmissive display to display a virtual item button for item selection while the imager is capturing an image of the operation panel,
recognizes, based on an output of the sight line detector, the virtual item button selected, and
recognizes, as a selected item, an item corresponding to the virtual item button selected,
wherein the item is one of a plurality of kinds of items which are classified in a hierarchical structure, and
wherein, when the selected item belongs to a lowest hierarchical layer,
the processor causes the HMD communicator to transmit, to the main-apparatus communicator, a first notification indicating the selected item,
the controller, based on the first notification, causes the display panel to display a setting-value setting screen for setting a setting value for the selected item, and
the operation portion accepts setting of the setting value.

2. The display input device according to claim 1,
wherein, when the selected item does not belong to the lowest hierarchical layer, the processor
causes the transmissive display to display an item display image indicating the selected item, and
causes the transmissive display to display, around the item display image, the virtual item button corresponding to the item classified as belonging to a hierarchical layer immediately below a hierarchical layer to which the selected item belongs.

3. The display input device according to claim 1,
wherein, while the transmissive display is displaying the virtual item button, the controller causes the display panel to display a single-color screen.

4. The display input device according to claim 1,
wherein the processor causes the transmissive display to display a message telling that it is necessary to operate the operation portion of the main apparatus to execute a job.

5. The display input device according to claim 4,
wherein, when the operation portion has accepted setting of the setting value,
the controller causes the main-apparatus communicator to transmit, to the HMD communicator, a second notification indicating that the setting value has been set, and
the processor causes the transmissive display to keep displaying the message for a period from when the item belonging to the lowest hierarchical layer is selected to when the second notification is received.

6. The display input device according to claim 1,
wherein, when the operation portion has accepted setting of the setting value,
the controller causes the main-apparatus communicator to transmit, to the HMD communicator, a second notification indicating that the setting value has been set, and
the processor keeps the transmissive display from displaying a virtual button for a period from when the virtual item button corresponding to the item classified as belonging to the lowest hierarchical layer is selected to when the second notification is received.

7. The display input device according to claim 1,
wherein the processor causes the transmissive display to display the virtual item button such that an angle between any two adjacent lines each connecting a center of a display region of the head mount display and a center of the virtual item button is equal to an angle obtained by dividing an angle of 360° by a number of the virtual item button displayed.

8. The display input device according to claim 1,
wherein the processor causes the transmissive display to display the virtual item button to be aligned in one or both of a longitudinal direction and a lateral direction.

9. The display input device according to claim 1,
wherein the controller causes the display panel to display a home screen for selecting a job kind, and
wherein, while the imager is capturing an image of the home screen, the processor
causes the transmissive display to display a virtual job kind button for selecting a job kind,
recognizes, based on an output of the sight line detector, the virtual job kind button selected, and
causes the transmissive display to display the virtual item button corresponding to the item which is related to a selected job kind and classified as belonging to a highest hierarchical layer.

10. The display input device according to claim 1,
wherein, on recognizing that capturing of an image of the operation panel has been started, the processor causes the HMD communicator to transmit a request for information about a button displayed on the display panel,
wherein the controller causes the main-apparatus communicator to transmit, to the HMD communicator, a response including information indicating a kind of the button displayed on the display panel, and
wherein the processor, based on the response, causes the transmissive display to virtually display the button.

11. A method for controlling a display input device, the method comprising:
including a head mount display and a main apparatus in a display input device;
causing a virtual image to be visually recognized using the head mount display while the head mount display transmitting external light;
detecting a sight line of a user using the head mount display;
providing the main apparatus with an operation panel which includes a display panel and an operation portion;
controlling display on the display panel using the main apparatus;
displaying, on the head mount display, a virtual item button for selecting an item while an imager of the head mount display is capturing an image of the operation panel;
recognizing, based on a detected sight line, the virtual item button selected;
recognizing, as a selected item, an item corresponding to the virtual item button selected;
the item being one of a plurality of kinds of items which are classified in a hierarchical structure;
the head mount display transmitting, to the main apparatus, a first notification indicating the selected item, when the selected item belongs to a lowest hierarchical layer;
the display panel displaying, based on the first notification, a setting-value setting screen for setting a setting value for the selected item; and
accepting setting of the setting value.
